(19) United States
(12) Patent Application Publication
(10) Pub. No.: US 2009/0096332 A1
(43) Pub. Date: Apr. 16, 2009

(54) Refrigerator and/or freezer

(76) Inventor: Karl Benigni, Oberdrauburg (AT)

Correspondence Address: DILWORTH & BARRESE, LLP, 333 EARLE OVINGTON BLVD., SUITE 702, UNIONDALE, NY, 11553, US

(21) Appl. No.: 12/284,213

(22) Filed: Sep. 19, 2008

(30) Foreign Application Priority Data
Sep. 20, 2007 (DE) UM 202007013172.0

(51) Int. Cl. F16B 12/00; A47B 96/00

(52) U.S. Cl. 312/111; 312/404

(57) ABSTRACT

The present invention relates to a refrigerator and/or freezer with at least one interconnecting element extending between two compartments of the appliance, wherein one or more holding members are provided, which are connected with the inner container of the appliance and on which the interconnecting element is arranged such that the holding member at least partly extends between the inner container and the interconnecting element.

### BACKGROUND OF THE INVENTION

The present invention relates to a refrigerator and/or freezer with at least one interconnecting element extending between two compartments of the appliance.

Refrigerators and/or freezers with two or more than two separate compartments are known in a number of different embodiments. The individual compartments each have a door, between which a metallic interconnecting element extends in the appliances known from the prior art, which stabilizes the housing and provides the supporting surface for the magnetic door seals.

Novel appliances have a housing structure, in which the inner container is only made in one piece, which results in that the interconnecting element makes a firm mechanical connection with the inner container only at the two outer portions. In the middle portion, the interconnecting element is attached to the inner container only by the PU foam or multi-component foam used for insulating purposes.

Such mounting of the interconnecting element does not ensure process safety and a sufficient service life due to several parameters such as foaming temperature, foam ageing, tensile magnetic force, penetration of various media, etc.

### SUMMARY OF THE INVENTION

Therefore, it is the object underlying the present invention to develop a refrigerator and/or freezer as mentioned above such that a permanently stable attachment of the interconnecting element is achieved.

This object is solved by a refrigerator and/or freezer with the features herein of claim 1. Accordingly, it is provided that one or more holding members are provided, which are connected with the inner container of the appliance and on which the interconnecting element is arranged such that the holding member at least partly extends between the inner container and the interconnecting element. In accordance with the invention, one or more additional holding members thus are provided, by means of which the interconnecting element preferably is indirectly fixed at the inner container along its entire length. Largely any kind of attachment of the holding member(s) to the inner container is possible. Mechanical fastening means such as screws, clips, rivets, etc. are conceivable.

With the configuration of the appliance in accordance with the invention it is furthermore possible to meet the requirement of a floating inner container, which is required for foaming the appliances, although this is no absolutely necessary feature of the present invention.

The holding member(s) can be mounted to the inner container without a major additional effort. By means of the holding member(s) it is possible to permanently fix the interconnecting element at the inner container or at the holding member(s) connected with the inner container. Bulging of the interconnecting element to the front thus can be avoided in accordance with the invention.

As explained above, the holding member(s) can be connected with the inner container by means of a mechanical connection. The connection between holding member and inner container can for instance be effected by a screw, clip or rivet connection.

The present invention can be realized with one holding member or also with a plurality of holding members which preferably are arranged one beside the other.

The holding member(s) can include at least one holder, which preferably constitutes a web and by means of which the interconnecting element is positively fixed at the holding member. Other configurations such as a frictional connection of the interconnecting element to the holding member(s) are of course also conceivable.

In a further aspect of the invention it is provided that the holding member(s) include(s) at least one holder for receiving a frame heater.

Furthermore, it can be provided that the holding member(s) include(s) at least one bore for receiving a fastening element, preferably a screw, for fixing at the inner container. This bore can be disposed for instance in a region between two holders for fixing the interconnecting element at the holding member.

As explained, the connection between the holding member(s) and the inner container can be effected by means of a screw connection. It can be provided that on the side of the inner container facing away from the at least one holding member a receiving element is disposed, in which the screw, for instance the threaded portion thereof, is at least partly received.

The receiving element can include one, two or more than two, preferably a plurality of bores for receiving a portion of the screw. The advantage of using such receiving element consists in that the same need not be positioned exactly. Rather, approximately positioning the same is sufficient due to the plurality of existing bores. By means of the receiving element, the screw and thus the holding member is safely fixed.

In a further aspect of the invention it is provided that the receiving element is bonded to the side of the inner container facing away from the holding member(s). It is conceivable that the receiving element includes an adhesive layer, by means of which it is arranged on the inside of the inner container.

The holding member(s) can extend along the entire length or along an essential part of the length of the interconnecting element, which involves the advantage that the interconnecting element is mechanically fixed in a particularly safe way and the probability for the bulging of the interconnecting element is minimized.

As explained above, an advantageous aspect of the invention consists in that the inner container is floatingly accommodated in the appliance.

### BRIEF DESCRIPTION OF THE DRAWINGS

Further details and advantages of the invention will be explained with reference to an embodiment illustrated in the drawing, in which:

FIG. 1: shows a sectional representation through the refrigerator and/or freezer of the invention at the level of the interconnecting element, and

FIG. 2: shows a perspective representation of a holding member in accordance with the present invention.

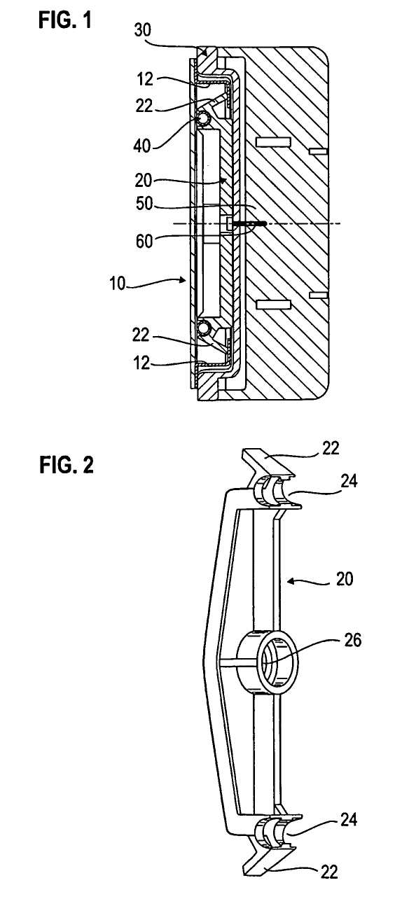

FIG. 1 shows the region of a refrigerator and/or freezer at the level of the interconnecting element 10 in a sectional representation.

### DESCRIPTION OF THE PREFERRED EMBODIMENTS

The refrigerator and/or freezer includes at least two separate compartments which can each be closed by a door or flap and between which the interconnecting element 10 shown in FIG. 1 extends on the front side. The interconnecting element 10 constitutes a strip extending in transverse direction of the appliance.

In FIG. 1, reference numeral 30 designates the inner container, which is slightly set back at the level of the interconnecting element 10, i.e. has an indentation extending in transverse direction of the appliance. Between the interconnecting element 10 and the one- or multi-part inner container 30 the holding member 20 shown in perspective in FIG. 2 extends in the vicinity of said indentation.

Via a screw connection, i.e. by means of the screw 60 shown in FIG. 1, the holding member 20 is connected with the inner container 30. The screw 60 is guided through the bore 26 of the holding member 20 and fixed in the receiving element 50, which is located on the side of the inner container 30 facing away from the holding member 20.

The receiving element 50 includes a plurality of bores and is bonded to the inside of the inner container 30. It is the function of the receiving element 50 to form a bearing for the screw 60, so as to reliably fix the holding member(s) 20 at the inner container 30.

As can in particular also be taken from FIG. 2, the holding member 20 has a substantially vertical extension and is connected with one holder 22 each at its upper and lower edge portions. This holder is positively connected with an angled protrusion 12 of the interconnecting element 10 and thus retains the interconnecting element 10 at the holding member 20, as can be taken in particular from FIG. 1.

In the vicinity of the holders 22, there is furthermore provided one holder 24 each for receiving a frame heater 40.

By using the holding member 20 of the invention, a permanent and exact positioning of the interconnecting element 10 at the inner container 30 also is ensured, if the insulating foam should loose its holding force after some years. Furthermore, the holding member 20 provides for an exact positioning of the frame heater 40.

As a further advantage, it should be mentioned that a floating support of the inner container 30 is possible, which is advantageous when foaming the appliance.

As explained above, one holding member or also several holding members can be used to connect the interconnecting element 10 with the inner container 30.

In contrast to the embodiment shown in FIG. 2, the holding member 2 can be configured wider and thus extend over a greater part of the interconnecting element in transverse direction. As explained above, the use of several holding members arranged for instance one beside the other also is conceivable.

1. A refrigerator and/or freezer with at least one interconnecting element (10) extending between two compartments of the appliance, wherein one or more holding members (20) are provided, which are connected with the inner container (30) of the appliance and on which the interconnecting element (10) is arranged such that the holding member (20) at least partly extends between the inner container (30) and the interconnecting element (10).

2. The refrigerator and/or freezer according to claim 1, wherein the holding member(s) (20) is(are) connected with the inner container (30) by a mechanical connection.

3. The refrigerator and/or freezer according to claim 2, wherein the holding member(s) is(are) connected with the inner container (30) by a screw, clip or rivet connection.

4. The refrigerator and/or freezer according to claim 1, wherein a plurality of holding members (20) arranged one beside the other are provided, which are connected with the inner container (30) and hold the interconnecting element (10).

5. The refrigerator and/or freezer according to claim 1, wherein the holding member(s) (20) includes(include) at least one holder (22), by which the interconnecting element (10) is positively and/or frictionally fixed at the holding member (20).

6. The refrigerator and/or freezer according to claim 5, wherein the holder (22) constitutes a web extending from the holding member (20) at an angle.

7. The refrigerator and/or freezer according to claim 1, wherein the holding member(s) (20) includes(include) at least one holder (24) for receiving a frame heater (40).

8. The refrigerator and/or freezer according to claim 1, wherein the holding member(s) (20) includes(include) at least one bore (26) for receiving a fastening means for fastening the holding member (20) to the inner container (30).

9. The refrigerator and/or freezer according to claim 1, wherein the holding member(s) (20) is(are) connected with the inner container (30) by means of a screw connection and that on the side of the inner container (30) facing away from the at least one holding member (20) a receiving element (50) is disposed for at least partly receiving the screw (60).

10. The refrigerator and/or freezer according to claim 9, wherein the receiving element includes one, two or more than two, preferably a plurality of bores for receiving a portion of the screw (60).

11. The refrigerator and/or freezer according to claim 9, wherein the receiving element (50) is bonded to the side of the inner container (30) facing away from the holding member(s) (20).

12. The refrigerator and/or freezer according to claim 1, wherein along the entire length or along an essential part of the length of the interconnecting element (10) the holding member(s) (20) is(are) connected with the same and with the inner container (30).

13. The refrigerator and/or freezer according to claim 1, wherein the inner container (30) is floatingly accommodated in the appliance.

14. The refrigerator and/or freezer according to claim 2, wherein a plurality of holding members (20) arranged one beside the other are provided, which are connected with the inner container (30) and hold the interconnecting element (10).

15. The refrigerator and/or freezer according to claim 3, wherein a plurality of holding members (20) arranged one beside the other are provided, which are connected with the inner container (30) and hold the interconnecting element (10).

16. The refrigerator and/or freezer according to claim 15, wherein the holding member(s) (20) includes(include) at least one holder (22), by which the interconnecting element (10) is positively and/or frictionally fixed at the holding member (20).

17. The refrigerator and/or freezer according to claim 14, wherein the holding member(s) (20) includes(include) at least one holder (22), by which the interconnecting element (10) is positively and/or frictionally fixed at the holding member (20).

18. The refrigerator and/or freezer according to claim 2, wherein the holding member(s) (20) includes(include) at least one holder (22), by which the interconnecting element (10) is positively and/or frictionally fixed at the holding member (20).

19. The refrigerator and/or freezer according to claim 3, wherein the holding member(s) (20) includes(include) at least one holder (22), by which the interconnecting element (10) is positively and/or frictionally fixed at the holding member (20).

20. The refrigerator and/or freezer according to claim 4, wherein the holding member(s) (20) includes(include) at least one holder (22), by which the interconnecting element (10) is positively and/or frictionally fixed at the holding member (20).
